(19) United States
(12) Patent Application Publication
(10) Pub. No.: US 2012/0293523 A1
(43) Pub. Date: Nov. 22, 2012

(54) MOBILE ELECTRONIC DEVICE AND DISPLAY CONTROL METHOD

(75) Inventors: Tsuneo Miyashita, Yokohama-shi (JP); Ryosuke Kokaji, Yokohama-shi (JP)

(73) Assignee: KYOCERA CORPORATION, Kyoto (JP)

(21) Appl. No.: 13/575,389

(22) PCT Filed: Jan. 27, 2011
(86) PCT No.: PCT/JP2011/051661

§ 371 Date: Jul. 26, 2012

(30) Foreign Application Priority Data
Jan. 27, 2010 (JP) 2010-015349

(51) Int. Cl. G06T 1/00

(52) U.S. Cl. 345/522

(57) ABSTRACT

According to an aspect, a mobile electronic device includes an operating, a display unit, a storage unit, and a control unit. The display unit displays an idle screen. The storage unit stores a first object corresponding to first information and a second object corresponding to second information. The control unit executes a first display process for displaying the first object on the idle screen when the idle screen is displayed. The control unit executes a second display process for displaying the second object on the idle screen when a preset condition is satisfied after the first display process is executed.

### CROSS-REFERENCE TO RELATED APPLICATION

This application is a National Stage of international application No. PCT/JP2011/051661 filed on Jan. 27, 2011 which designates the United States, and which is based upon and claims the benefit of priority from Japanese Patent Application No. 2010-015349, filed on Jan. 27, 2010.

### FIELD

The present disclosure relates to a mobile electronic device, including a display unit which can display an idle screen, and a display control method thereof.

### BACKGROUND

Some mobile electronic devices include a display unit. An example of this mobile electronic device is a communication device disclosed in Patent Literature 1. This communication device is so-called a mobile phone. This mobile phone is configured to display a to-be-attached object (e.g., a memo pad), registered in accordance with a user operation, on an idle screen in the display unit of the mobile phone.

### CITATION LIST

### Patent Literature

Patent Literature 1: Japanese Patent Application Laid-Open No. 2005-110059

### TECHNICAL PROBLEM

However, there is a limit in the number of displayable to-be-attached objects that can be displayed on the idle screen. When the number of registered objects exceeds the number of displayable objects, it is difficult to display all of the registered to-be-attached objects on the idle screen. Even if the to-be-attached objects to be displayed on the idle screen are registered, they may not entirely be displayed on the idle screen.

For the foregoing reasons, there is a need for a mobile electronic device and a display control method thereof, which can efficiently display objects on an idle screen.

### SUMMARY

According to an aspect, a mobile electronic device includes: an operating unit; a display unit for displaying an idle screen; a storage unit for storing a first object corresponding to predetermined information and a second object corresponding to information different from that of the first object; and a control unit for executing a first display process for displaying the first object when a state of the mobile electronic device is changed to an awaiting state awaiting communication occurrence or activation of a function of the mobile electronic device, and for executing a second display process for displaying an object including the second object on the idle screen when a preset condition is satisfied after the first display process is executed.

Preferably, the first object is text information including a letter.

According to another aspect, the second object is a shortcut function for various information stored in the storage unit.

According to another aspect, the condition is satisfied when a preset first predetermined period of time has elapsed.

According to another aspect, the control unit displays only the second object on the idle screen in the second display process, of the first object and the second object.

According to another aspect, the control unit displays the first object together with the second object on the idle screen, in the second display process.

According to another aspect, the storage unit stores a shortcut function for various information stored in the storage unit, as the second object. In execution of the second display process, the control unit executes an explanatory display regarding the shortcut function when the shortcut function displayed on the idle screen is selected in accordance with an operation of the operating unit, and executes an icon display regarding the shortcut function when the shortcut function displayed on the idle screen is not selected.

According to another aspect, the control unit accesses various information corresponding to the shortcut function when the selected shortcut function is decided in accordance with an operation of the operating unit in a state where the shortcut function displayed on the idle screen is selected, in execution of the second display process.

According to another aspect, the storage unit stores text information including a letter, as the first object, and the control unit executes a detail display regarding the text information when the text information displayed on the idle screen is selected and decided in accordance with an operation of the operating unit, in execution of the first display process.

According to another aspect, the storage unit stores a plurality of text information including a letter, as the first object; and the control unit displays different text information to be displayed, every time the first display process is executed.

According to another aspect, the operating unit has a function call key which is operated to execute a predetermined function, and the control unit changes from the display process for the idle screen to the display process for the predetermined function when the function call key of the operating unit is operated, in a state where the idle screen is displayed.

According to an aspect, a display control method is with respect to a mobile electronic device including an operating unit, a display unit for displaying an idle screen, and a storage unit for storing various information, wherein the storage unit stores a first object corresponding to predetermined information and a second object corresponding to information different from the first object. The method includes: a first displaying step of displaying the first object in an awaiting state awaiting communication occurrence or activation of a function of the device; and a second displaying step of displaying an object including the second object on the idle screen, when a preset condition is satisfied after the first displaying step is executed.

### ADVANTAGEOUS EFFECTS OF INVENTION

According to the present invention, a high priority object can be displayed on an idle screen, at the activation of the idle screen.

### BRIEF DESCRIPTION OF DRAWINGS

FIG. 1 is a front view illustrating a mobile electronic device according to an embodiment.

FIG. 2 is a block diagram illustrating a schematic configuration of functions of the mobile electronic device illustrated in FIG. 1.

FIG. 3 is an explanatory diagram of a type table.

FIG. 4 is an explanatory diagram of a priority table.

FIG. 5 is a flowchart illustrating an example of an operation for controlling the mobile electronic device.

FIG. 6 is an explanatory diagram illustrating an example of a transitional screen from a text object display to a shortcut object display.

FIG. 7 is an explanatory diagram illustrating another example of a transitional screen from a text object display to a shortcut object display.

FIG. 8 is an explanatory diagram illustrating still another example of a transitional screen from a text object display to a shortcut object display.

### DESCRIPTION OF EMBODIMENTS

The present invention will now be described with reference to the drawings. The embodiment (hereinafter referred to as “embodiment”) for carrying out the invention is not to limit the present invention. Constituent elements of the following embodiment include those easily occur to the skilled in the art, and include those substantially identical or equivalent scope thereof. Descriptions will below be made to a mobile phone as one example of the mobile electronic device. However, the present invention may be applied not limited to the mobile phone, and may be applied to other systems, for example, PHSs (Personal Handyphone Systems), PDAs, portable navigation systems, and portable game machines.

### Embodiment

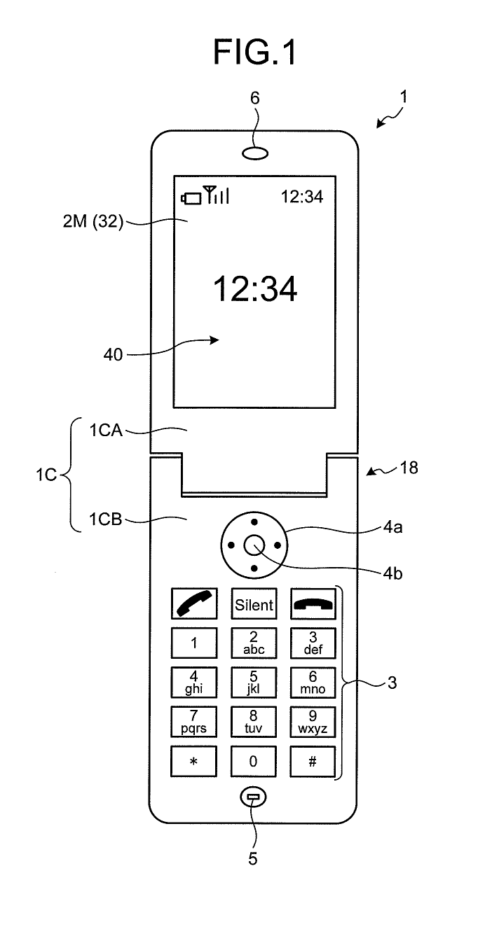

FIG. 1 is a front view illustrating a schematic configuration of the mobile electronic device according to one embodiment of the present invention. A mobile electronic device 1 is a mobile phone including a display unit 32 which can display an idle screen 40. The mobile electronic device 1 is a folding mobile phone, in which a housing 1C is foldable and unfoldable and formed of a first housing 1CA and a second housing 1CB. FIG. 1 illustrates a state in which the mobile phone 1 is unfolded.

The first housing 1CA has a main display 2M illustrated in FIG. 1 as a display unit 32. The main display 2M displays an idle screen 40 as a predetermined image. The idle screen 40 is a screen representing a state awaiting an outgoing or incoming telephone call or a state awaiting activation of application. In other words, the idle screen 40 is called a desktop screen, a home screen, a standby screen, or wallpaper, and indicates a screen to be changed to a plurality of functional screens displayed by the display unit 32 under the control of a main control unit 22. As illustrated in FIG. 1, the first housing 1CA has a receiver 6 generating a sound during telephone conversation with the mobile electronic device 1.

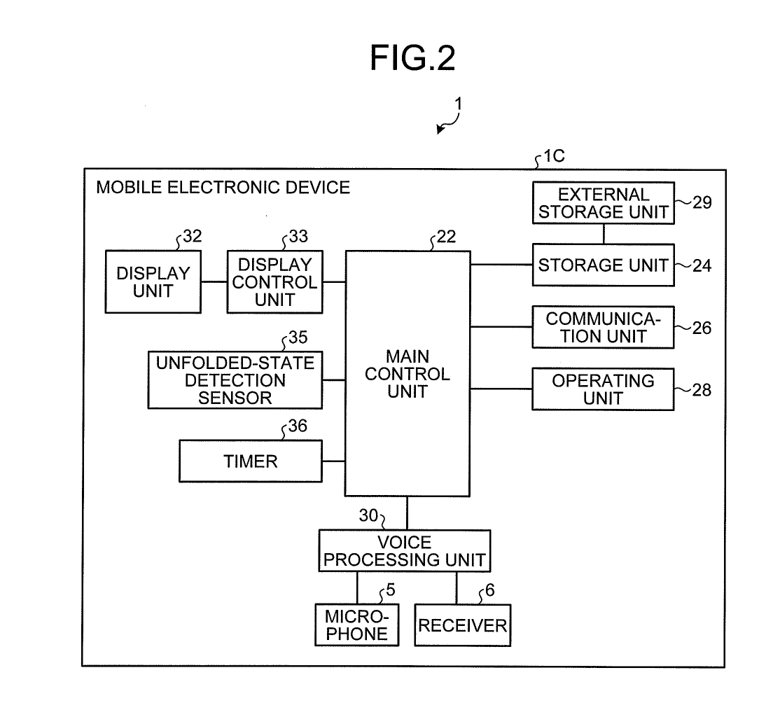

The second housing 1CB has a plurality of operation keys 3 for inputting a telephone number of a person to call and letters (or characters) at the time of composing an email message. The second housing 1CB has a direction key 4a and an Enter key 4b for easily executing selection and decision of a menu and scrolling of a screen, displayed on the main display 2M. The operation keys 3, the direction key 4a, and the Enter key 4b form an operating unit 28 of the mobile electronic device 1 (see FIG. 2). The second housing 1CB has a microphone 5 which receives a sound during the telephone conversation with the mobile electronic device 1.

The first housing 1CA and the second housing 1CB are connected through a hinge 18. With this configuration, the first housing 1CA and the second housing 1CB move around the hinge 18, and can move in a direction away from each other and in a direction toward each other. If the first housing 1CA and the second housing 1CB move around in a direction away from each other, the mobile electronic device 1 is unfolded. On the other hand, if the first housing 1CA and the second housing 1CB move around in a direction toward each other, the mobile electronic device 1 is folded.

Descriptions will now be made to the relationship between functions and a control system of the mobile electronic device 1. FIG. 2 is a block diagram illustrating a schematic configuration of the functions of the mobile electronic device illustrated in FIG. 1. As illustrated in FIG. 2, the mobile electronic device 1 has the main control unit 22, a storage unit 24, a communication unit 26, the operating unit 28, a voice processing unit 30, the display unit 32, a display control unit 33, an unfolded-state detection sensor 35, and a timer 36.

The main control unit 22 is a processing unit, for example, a CPU (Central Processing Unit), for integrally controlling the overall operations of the mobile electronic device 1. That is, the main control unit 22 controls operations of the communication unit 26, the display unit 32, and the like so that various processes of the mobile electronic device 1 are executed in an appropriate order in accordance with operations on the operating unit 28 and the software stored in the storage unit 24 of the mobile electronic device 1. The main control unit 22 executes processes based on the program stored in the storage unit 24 (for example, the operating system program and the application program). The main control unit 22 can parallelly execute a plurality of programs (application and software).

The storage unit 24 stores application programs and data for use in the processes of the main control unit 22. Specifically, the storage unit 24 stores, as the application programs: an application program for performing Internet communications; an application program for transmitting/receiving emails; an application program for reproducing voice data; an application program for an outgoing telephone call process, an incoming telephone call process, and a telephone conversation process; an application program for performing a one-segment broadcasting process; and an application program for displaying (attaching) an object to be attached onto the idle screen 40. The stored data includes image data, voice data, dictionary data for character conversion, phone book data, URL data, and object data (for example, text objects as will be described later) to be attached onto the idle screen 40. As an example of the object to be attached, the text object has been described. However, as long as an object is displayable on the idle screen, any object may be applied other than the text object.

The storage unit 24 is connectable to an external storage unit (medium) 29 which can store and read data, and stores data in the external storage unit (medium) 29 under the control of the main control unit 22. The main control unit 22 reads data stored in the external storage unit (medium) 29, and transmits the read data to the main control unit 22.

The communication unit 26 establishes a wireless signal path using a CDMA system with respect to a base station, through a channel allotted by the base station, and performs telephone communication and information communication with the base station. The communication unit 26 includes an antenna for receiving television broadcasting and an antenna for receiving GPS signals.

The operating unit 28 includes, operation keys 3 with various allotted functions, for example, a power key, a conversation key, numerical keys, letter (character) keys, an outgoing call key, and a function call key, the direction key 4a, and the enter key 4b. When these keys are input through user operations, a signal corresponding to the detail of the operation is generated. Then, the generated signal is input to the main control unit 22 as a user instruction.

The voice-processing unit 30 executes processing for a voice signal input to the microphone 5 and a voice signal output from the receiver 6.

The display unit 32 has a display panel (for example, the above-described main display 2M) including an LCD (Liquid Crystal Display), an organic EL (Electro-Luminescence) panel, or the like. The display unit 32 controls the display panel to display a video image corresponding to video data supplied from the main control unit 22 through the display control unit 33 and an image corresponding to image data.

The unfolded-state detection sensor 35 detects that the mobile electronic device 1 is in an unfolded-state when the first housing 1CA and the second housing 1CB move around in a direction away from each other. When the unfolded-state detection sensor 35 detects that the mobile electronic device 1 is in an unfolded-state, the main control unit 22 displays various screens such as the idle screen 40, on the main display 2M.

The timer 36 counts the elapsed time since the measurement started. The timer 36 outputs the counted elapsed time to the connected main control unit 22. Then, the main control unit 22 executes various processes based on the elapsed time.

As described above, the storage unit 24 of the mobile electronic device 1 stores an application program for displaying an object to be attached onto the idle screen 40. This application program is configured to digitize the attached object created by the operation of the operating unit 28 and to register a plurality of digitized objects in the storage unit 24. This application program displays the registered object data to be attached as to-be-attached objects, on the idle screen 40. The objects, registered in the storage unit 24, to be attached are referred to as to-be-attached object data. However, for the sake of simple descriptions, the object will now simply be referred to as a “to-be-attached object”.

Examples of the to-be-attached object include a text object (text information) formed from letters, a URL shortcut for connecting to the Internet by accessing URL data, an image link for accessing image data, a phonebook shortcut for accessing phone book data, etc. The maximum number of displayable to-be-attached objects is smaller than the maximum number of registered to-be-attached objects. For example, the maximum number of to-be-attached objects to be registered in the storage unit 24 is twenty, while the maximum number of displayable to-be-attached objects to be displayed on the idle screen 40 is seven.

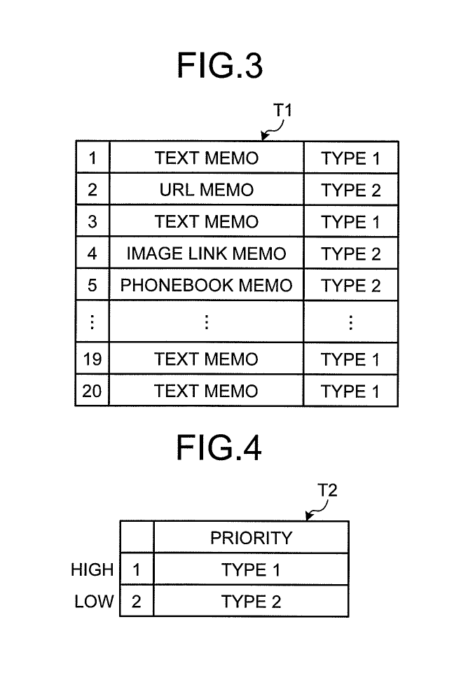

The storage unit 24 stores a type table T1 illustrated in FIG. 3 and a priority table T2 illustrated in FIG. 4. FIG. 3 is an explanatory diagram of the type table, while FIG. 4 is an explanatory diagram of the priority table.

In the type table T1, kinds of the registered to-be-attached objects are associated with predetermined types. Specifically, the predetermined types include a “type 1” and a “type 2”. The text objects correspond to “type 1”, while objects other than the text objects corresponds to “type 2”. That is, in the type table T1, the to-be-attached objects are classified according to “text object (first object)” and “object other than text object”. Specifically, objects other than the text objects include the above-described URL shortcut, an image link, a phonebook shortcut, etc. These are so-called shortcut objects (second objects: shortcut functions) that are accessible to various information stored in the storage unit 24. The types, “type 1” and “type 2”, are automatically allotted in accordance with the types of the to-be-attached objects, when the to-be-attached objects are registered.

In the priority table T2, the types are associated with priorities. Specifically, in the priority table T2, a “priority 1” as a high priority is given to “type 1”, while a “priority 2” as a low priority is given to “type 2”. As will be described later, the main control unit 22 of the mobile electronic device 1 controls the to-be-attached object with a high priority to be preferentially displayed on the idle screen 40.

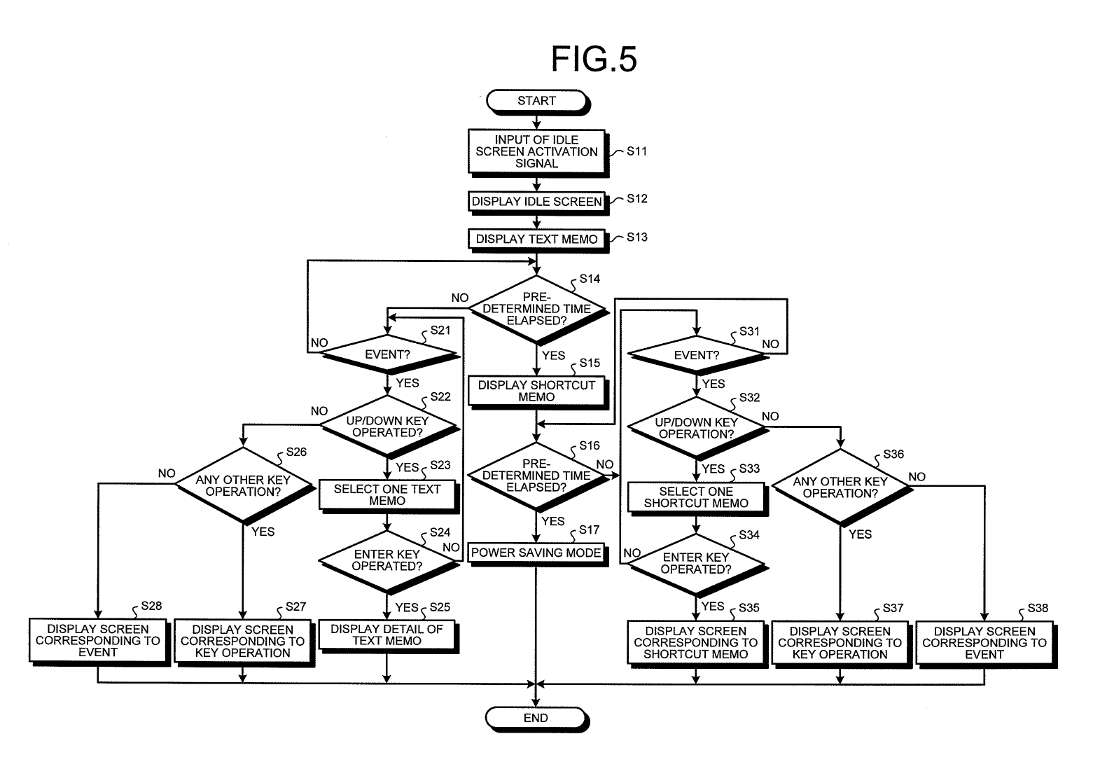

Then, descriptions will now be made to an operation for controlling the above-described configured mobile electronic device 1 (display control method), with reference to FIG. 5. FIG. 5 is a flowchart illustrating an example of the operation for controlling the mobile electronic device.

The main control unit 22 of the mobile electronic device 1 detects whether a condition (idle screen activation signal) for activating the idle screen 40 is satisfied (Step S11). The condition for activating the idle screen 40 is satisfied when the mobile electronic device 1 is changed to an unfolded state, or when the state of the mobile electronic device 1 is changed from an OFF state to an ON state. The condition for activating the idle screen 40 is also satisfied when the mobile electronic device 1 is in a wakeup state (non-power saving state) in which the display unit 32 restarts the displaying, upon an operation on the operating unit 28. This wakeup state is changed from a sleep state (power saving state) in which power consumption is eliminated by turning off the display unit 32, when the mobile electronic device 1 keeps in a non-operation state for a predetermined period of time (equal to a second predetermined period of time, as will be described later). Further, for example, the condition for activating the idle screen 40 is satisfied when activation of any of the entire functions is waited for, upon pressing of a call-ending key or a home key during any of a function operation. The main control unit 22 controls the main display 2M to display the idle screen 40, upon detection of the satisfied condition for activating the idle screen 40 (Step S12).

The main control unit 22 executes a text display process (first display process) for displaying only a text object on the idle screen 40, after controlling the main display 2M to display the idle screen 40 (Step S13: first display step). Specifically, the main control unit 22 extracts the type with the highest priority from the priority table T2. Thus, the main control unit 22 extracts “type 1” as the type with the highest priority. Subsequently, the main control unit 22 extracts the to-be-attached object(s) corresponding to “type 1” from the type table T1. Thus, the main control unit 22 extracts text object(s) of “type 1”. The main control unit 22 displays the extracted text object(s) on the idle screen 40 of the main display 2M. Accordingly, the main control unit 22 executes a text display process for displaying a plurality of text objects of “type 1” as “priority 1” on the idle screen 40 of the main display 2M, side by side. At this stage, simple display is made, showing approximately the head ten letters of the text object.

The main control unit 22 judges whether a first predetermined period of time as a preset condition has elapsed based on a measurement result of the timer 36, since the execution of the text display process as the starting time of the measurement, after the procedure of Step S13 (Step S14). This first predetermined period of time may arbitrarily be set. The main control unit 22 moves to Step S21, until the preset first predetermined period of time will have elapsed (Step S14: No).

The main control unit 22 changes to a shortcut display process (second display process) for displaying shortcut object(s) on the idle screen 40, after the preset first predetermined period of time has elapsed (Step S14: Yes) (Step S15: second display step). The main control unit 22 may move on from Step S14 to Step S15, when an operation for canceling the display of the text object is made. Specifically, the main control unit 22 extracts a particular type of object with a lower priority than “priority 1”, that is, a type of an object with a high priority next to “priority 1”, from the priority table T2. Thus, the main control unit 22 extracts “type 2” as the type with “priority 2”. Subsequently, the main control unit 22 extracts the to-be-attached object(s) of “type 2” from the type table T1. Thus, the main control unit 22 extracts the shortcut object(s) of “type 2”. The main control unit 22 displays the extracted shortcut object(s) on the idle screen 40 of the main display 2M. Accordingly, the main control unit 22 executes a shortcut display process for displaying a plurality of shortcut objects of “type 2” with “priority 2” on the idle screen 40 of the main display 2M, side by side. At this stage, simple display is made, showing icons representing registered names, function names, data names, or the like of the shortcut objects. In this embodiment, the text objects are displayed after displaying the idle screen 40. After this, the display is changed to display the shortcut objects. However, without displaying the idle screen 40, the text objects may be displayed first. Then, at the time the first predetermined period of time has elapsed, the idle screen 40 may be controlled to be displayed at the first time upon display of the shortcut objects.

The main control unit 22 judges whether a preset second predetermined period of time has elapsed based on a measurement result of the timer 36, since the execution of the shortcut display process as the starting time of the measurement, after the procedure of Step S15 (Step S16). This second predetermined period of time may be also arbitrarily set. The main control unit 22 moves on to Step S31, until the preset second predetermined period of time will have elapsed (Step S16: No). The main control unit 22 shifts the mobile electronic device 1 into a power saving mode (Step S17), when the preset second predetermined period of time has elapsed (Step 16: Yes). The main display 2M of the mobile electronic device 1 in a power saving mode will be in a sleep state in which the screen is turned off to create a blackout. The main control unit 22 ends this process, when it controls the mobile electronic device 1 to be in a power saving mode.

Subsequently, descriptions will now be made to a control operation by the main control unit 22 of the mobile electronic device 1, in Step S14, before the preset first predetermined period of time will have elapsed (Step S14: No).

The main control unit 22 judges whether an event has occurred (Step S21), before the preset first predetermined period of time has elapsed (Step S14: No), in Step S14. In this case, an event implies a process which occurs when the operating unit 28 is operated, a process which occurs based on an externally input signal, and a process which occurs based on pre-input setting. The main control unit 22 moves on to Step S14 again, if no event occurs (Step S21: No). That is, the main control unit 22 repeats the procedures of Step S14 and Step 21, if no event occurs until the first predetermined period of time has elapsed. On the contrary, if an event occurs (Step S21: Yes), the main control unit 22 judges whether this event is made based on an up/down operation with the direction key 4a (Step S22).

If the event is made based on an up/down operation with the direction key 4a in Step S22 (Step S22: Yes), the main control unit 22 selects a text object displayed on the main display 2M in accordance with the up/down operation of the direction key 4a (Step S23). After this selection, the main control unit 22 judges whether the Enter key 4b has been operated, in a state where the text object has been selected (Step S24). The main control unit 22 moves onto Step S21 again, if the Enter key 4b has not been operated (Step S24: No). On the contrary, if the Enter key 4b has been operated (Step S24: Yes), the main control unit 22 controls the main display 2M to display the detail display regarding the selected text object (Step S25). In this case, the detail display regarding the text object implies a detail display screen displaying the entire text of the text object. The main control unit 22 ends this process, after controlling the main display 2M to display the detail display screen.

If the generated event is not based on the up/down operation of the direction key 4a (Step S22: No), the main control unit 22 judges whether the event is generated based on any other key operation (Step S26). In this embodiment, any other key may be any of the operation keys 3, such as a telephone call key, numerical keys, and a function call key (for example, a Web key, an email key).

In Step S26, if the event is made based on any other key operation (Step S26: Yes), the main control unit 22 controls the main display 2M to display a screen corresponding to the any other key operation (Step S27). Specifically, upon operation of the telephone call or numerical key, the main control unit 22 controls the main display 2M to display a screen showing numerals corresponding to operated numerical keys, that is, a telephone number input screen after the entire display of the to-be-attached objects is turned off. When a Web key is operated as a function call key, the main control unit 22 controls the main display 2M to display an Internet connection screen. Further, as a function call key, when an email key is operated, the main control unit 22 controls the main display 2M to display an email BOX screen. The main control unit 22 ends this process, after controlling the main display 2M to display the screen corresponding to the key operation.

In Step S26, if the event is generated not based on the any other key operation (Step S26: No), that is, if the event is not generated based on the any other key operation, the main control unit 22 controls the main display 2M to display a screen corresponding to the generated event (Step S28). Examples of the event not generated based on a key operation include an event generated based on an incoming telephone call or an email, an event generated in response to an alarm sound at a preset time, an event generated when the battery level of the mobile electronic device 1 decreases, etc. Examples of screens corresponding to any of those events include an incoming screen reporting an incoming telephone call or an email, an alarm sound screen displayed at the time of alarm sounding, a power OFF transitional screen reporting “Power OFF” of the mobile electronic device 1 when the battery level decreases, etc. The main control unit 22 ends this process, after controlling the main display 2M to display a screen corresponding to the generated event. Needless to say, the to-be-attached object is not displayed in the email BOX screen, the Internet connection screen, the incoming telephone call reporting screen, the alarm sound screen, and the power OFF transitional screen.

Subsequently, descriptions will now be made to a control operation by the main control unit 22 of the mobile electronic device 1, when an event is generated before the preset second predetermined period of time has elapsed in Step S16 (Step S16: No).

In Step S16, before the preset second predetermined period of time has elapsed in Step S16 (Step S16: No), the main control unit 22 judges whether an event has been generated (Step S31). The main control unit 22 moves onto Step S16 again, if no event has been generated (Step S31: No). That is, the main control unit 22 repeats the procedures of Step S16 and Step S31, if a “no-event” state keeps, until the second predetermined period of time has elapsed. On the contrary, if an event has been generated (Step S31: Yes), the main control unit 22 judges whether the generated event is based on an up/down operation of the direction key 4a (Step S32).

If the event is based on the up/down operation of the direction key 4a in Step S32 (Step 32: Yes), the main control unit 22 selects one shortcut object displayed on the main display 2M in accordance with the up/down operation of the direction key 4a (Step S33). At this time, when the shortcut object is selected, the main control unit 22 controls the main display 2M to display the explanatory display regarding the selected shortcut object. The explanatory display regarding the shortcut object implies a display screen for explaining the function of the shortcut.

The main control unit 22 judges whether the Enter key 4b has been operated, in a state where the shortcut object is being selected (Step S34). The main control unit 22 moves onto Step S31 again, when the Enter key 4b has not been operated (Step S34: No). When the Enter key 4b has been operated (Step S34: Yes), the main control unit 22 controls the main display 2M to display a screen corresponding to the selected shortcut object (Step S35). Specifically, when the selected shortcut object is a URL shortcut, the main control unit 22 controls the main display 2M to display the Internet connection screen for a target URL. When the selected shortcut object is an image link, the main control unit 22 controls the main display 2M to display image data of the target link. Further, when the selected shortcut object is a phonebook shortcut, the main control unit 22 controls the main display 2M to display phonebook data of a registered destination. The main control unit 22 ends this process, after controlling the main display 2M to display a screen corresponding to the shortcut object.

When the event is generated not based on the up/down operation of the direction key 4a in Step S32 (Step S32: No), the main control unit 22 judges whether the event has been generated based on any other key operation (Step S36). The procedures of Step S36, S37, and S38 are substantially the same as those of Step S26, S27, and S28. Thus, a part of these same procedures will not and repeatedly be described again.

When the event is generated based on the any other key operation in Step S36 (Step S36: Yes), the main control unit 22 controls the main display 2M to display a screen corresponding to the any other key operation (S37), and ends this process.

When the event is generated not based on the any other key operation in Step S36 (Step S36: No), that is, when the event is not generated based on the any other key operation, the main control unit 22 controls the main display 2M to display a screen corresponding to any of various events (Step S38). The main control unit 22 ends this process, after controlling the main display 2M to display a screen corresponding to the generated event.

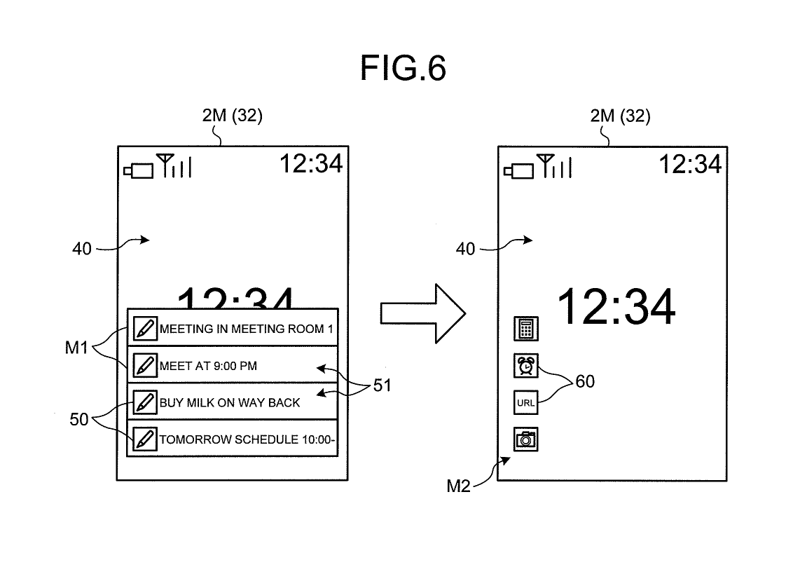

Descriptions will now be made to a screen transition of the idle screen 40, when the main control unit 22 changes from the text display process to the shortcut display process, with reference to FIG. 6. FIG. 6 is an explanatory diagram illustrating an example of a transitional screen from a text object display to a shortcut object display. The main control unit 22 controls the main display 2M to display the idle screen 40, in response to an instruction for activation of the idle screen 40. Then, the main control unit 20 executes a text display process for displaying only the text object(s) on the idle screen 40 of the main display 2M, based on the above-described control operation. When the text display process is executed, registered text objects M1 are displayed on the idle screen 40, as illustrated on the left side of FIG. 6. The displayed text objects M1 include icons 50 representing that the object is the text objects M1 and character information 51 representing the contents of the text objects M1. A plurality of displayed text objects M1 are displayed side by side in a vertical direction on the idle screen 40.

Thereafter, when the first predetermined period of time has elapsed, the main control unit 22 executes a shortcut individual display process (second object individual display process), as a shortcut display process for displaying only the shortcut object(s) on the idle screen 40 of the main display 2M, based on the above-described control operation. When the shortcut individual display process is executed, registered shortcut objects M2 are displayed on the idle screen 40, as illustrated on the right side of FIG. 6. The displayed shortcut objects M2 includes only icons 60 representing that the objects are the shortcut objects M2. A plurality of shortcut objects M2 are displayed side by side in a vertical direction on the idle screen 40.

According to the above-described configuration, the main control unit 22 is in a state awaiting an outgoing or incoming telephone call or awaiting an activation request for a function. In this state, when the screen of the idle screen 40 is activated, the text objects M1 with a high priority can be displayed on the idle screen 40. When the first predetermined period of time has elapsed, the shortcut objects M2 with a lower priority can be displayed on the idle screen 40. Accordingly, if a high priority is given to a target to-be-attached object to be displayed, the main control unit 22 can display the target to-be-attached object to be displayed on the idle screen 40 at a standby mode, without a user operation.

The main control unit 22 changes from the text display process to the shortcut display process. As a result, the to-be-attached objects can efficiently be displayed on the idle screen 40, even if the maximum number of to-be-attached objects to be displayed is smaller than the maximum number of registered to-be-attached objects. Thus, the main control unit 22 can display many of the registered to-be-attached objects on the idle screen 40.

In the execution of the shortcut display process, the shortcut objects M2 are displayed in the form of the icons 60 on the idle screen 40 of the main display 2M. Thus, the main control unit 22 can preferably display the idle screen 40 on the main display 2M without hiding the idle screen 40 behind the shortcut objects M2.

When the text objects M1 displayed on the idle screen 40 are selected with the operating unit 28, the main control unit 22 can display details of the text objects M1. Thus, the user can check the all text of the text objects M1 displayed on the idle screen 40, by operating the operating unit 28.

When the shortcut object M2 displayed on the idle screen 40 is selected with the operating unit 28, the main control unit 22 can display a screen corresponding to the shortcut object M2. Thus, the user can access information corresponding to the shortcut object M2 displayed on the idle screen 40, by operating the operating unit 28.

In the execution of the text display process and the shortcut display process, when any of the operation keys 3 (for example, function call key) is operated, the main control unit 22 can display a screen corresponding to this key operation on the main display 2M. Thus, even in the execution of the text display process and the shortcut display process, the main control unit 22 can display a screen corresponding to a predetermined function, by operating the operating unit 28.

The main control unit 22 can display different text objects M1, on the idle screen 40, every time the text display process is executed. Thus, the main control unit 22 can efficiently display the registered text objects M1, even if the number of registered text objects M1 is larger than the maximum number of to-be-attached objects to be displayed.

In the execution of the text display process, the main control unit 22 may display different text objects M1, on the idle screen 40, every time the text display process is executed, if the number of registered text objects M1 is larger than the maximum number of to-be-attached objects to be displayed on the idle screen 40.

That is, if the number (for example, four) of registered text objects is equal to or smaller than the maximum number (for example, seven) of to-be-attached objects to be displayed, the main control unit 22 can display all of the registered text objects M1 on the idle screen 40. If the number (for example, fourteen) of registered text objects M1 is larger than the maximum number (for example, seven) of to-be-attached objects to be displayed, the main control unit 22 cannot display all of the registered text objects M1 on the idle screen 40. In this case, in the execution of the text display process, the main control unit 22 first displays the seven text objects M1 on the idle screen 40. In the execution of the next text display process, the main control unit 22 displays the remaining seven text objects M1 on the idle screen 40. As a result, the main control 22 can efficiently display the registered text objects M1 on the idle screen 40. The main control unit 22 can display all of the text objects M2 on the idle screen 40, by repeating the text display process. Thus, the user can read all of the text objects M1, only by repeating the display operation of the idle screen 40.

In this embodiment, in the type table T1, various kinds of to-be-attached objects are classified into text objects M1 with “Type 1” and into shortcut objects M2 with “Type 2”. However, the present invention is not limited to this configuration. The to-be-attached objects may arbitrarily be classified into more than three kinds, and may be classified into any arbitrary types. In this case, in the priority table T2, priorities of “3” or higher may arbitrarily be given to the types of the to-be-attached objects classified into three or more.

In this embodiment, in the type table T1 and priority table T2, the types and priorities of the to-be-attached objects are automatically allotted thereto. However, the types and priorities may be set to the to-be-attached objects as required, by the user operating the operating unit 28.

In this embodiment, the kinds of the to-be-attached objects are associated with the priorities with the intervention of the types, using the type table T1 and the priority table T2. However, not limited to this, the kinds of the to-be-attached objects may be directly associated with the priorities. Without a limitation that the types are set to correspond to the kinds of the to-be-attached objects, the types and priorities may individually be set to the to-be-attached objects.

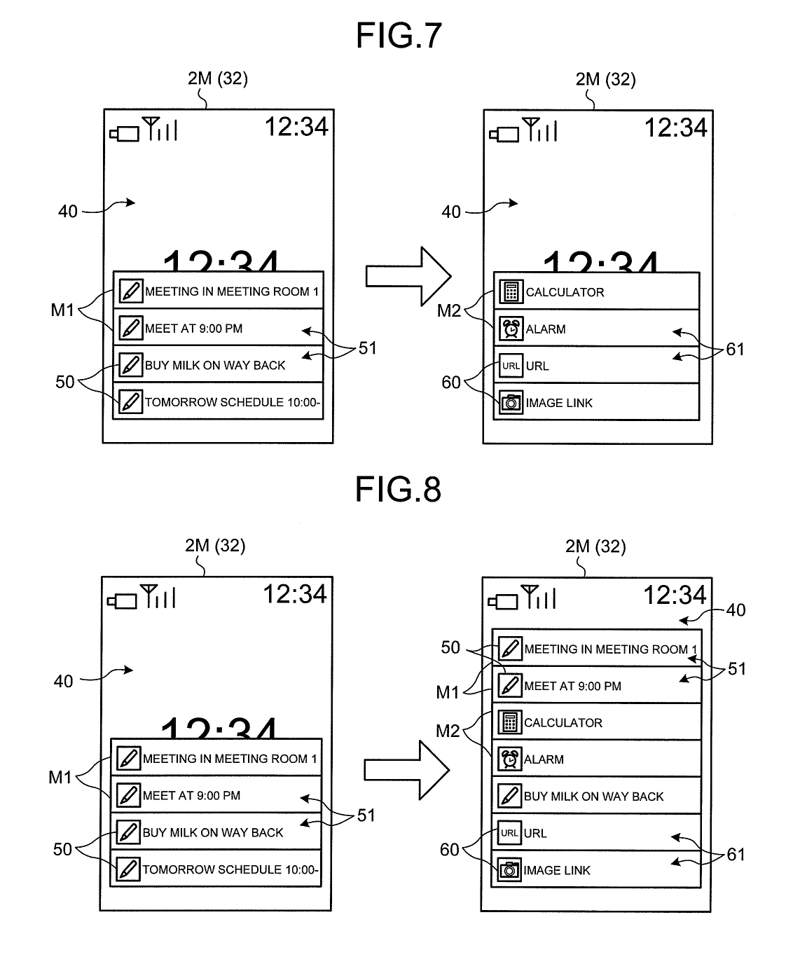

In this embodiment, the main control unit 22 displays only the icons 60, when the shortcut objects M2 are displayed on the idle screen 40 in accordance with the shortcut display process. However, when the idle screen 40 (left side of FIG. 7) displayed by the text display process is changed to the idle screen 40 (right side of FIG. 7) displayed by the shortcut display process, the shortcut objects M2 may represent explanatory information 61 regarding the shortcut objects M2 together with the icons 60, as illustrated on the right side of FIG. 7.

In this embodiment, the main control unit 22 executes a shortcut individual display process for displaying only the shortcut object(s) on the idle screen 40, as a shortcut display process. However, when the idle screen 40 (left side of FIG. 8) displayed by the text display process is changed to the idle screen 40 (right side of FIG. 8) displayed by the shortcut display process, the main control unit 22 may execute a mixed display process for displaying the text objects M1 together with the shortcut objects M2, as a shortcut display process. Specifically, the main control unit 22 extracts the type information from the priority table T2, regardless of the priorities. Thus, the main control unit 22 extracts all type information of the priority table T2, that is, extracts “Type 1” and “Type 2”. Subsequently, the main control unit 22 extracts to-be-attached objects of “Type 1” and “Type 2”, from the type table T1. Thus, the main control unit 22 extracts the text object M1 of “Type 1” and the shortcut object M2 of “Type 2”. The main control unit 22 controls the main display 2M to display the extracted text objects M1 and the shortcut objects M2 on the idle screen 40. Accordingly, the main control unit 22 executes the mixed display process for displaying the text objects M1 together with the shortcut objects M2, on the idle screen 40 of the main display 2M.

The mixed display process is not limited according to the above control method, and may be executed by changing the setting of the type table T1 or the priority table T2. That is, in the type table T1, the text objects M1 are set to correspond to “Type 1” and “Type 2”. As a result, the main control unit 22 can execute the mixed display process. In the priority table T2, “Type 1” and “Type 2” are set to correspond to “Priority 2”. As a result, the main control unit 22 may execute the mixed display process.

In this embodiment, the text object M1 has “Priority 1”, while the shortcut object M2 has “Priority 2”. However, the priorities may arbitrarily be set. For example, the shortcut object M2 may have “Priority 1”, while the text object M1 may have “Priority 2”.

In this embodiment, if the number of registered text objects M1 is larger than the maximum number of displayable to-be-attached objects to be displayed, the main control unit 22 displays different text objects M1 every time the text display process is executed. However, not limited to this configuration, if the number of registered text objects M1 is larger than the maximum number of displayable to-be-attached objects to be displayed, the main control unit 22 may automatically perform a scrolling display of the registered text objects M1 on the idle screen 40. In this case, the registered text objects M1 may efficiently be displayed on the idle screen 40.

### INDUSTRIAL APPLICABILITY

Accordingly, the mobile electronic device and display control method of the present invention are effective in a mobile electronic device including the display unit, and, more particularly, to a case of displaying a to-be-attached object on the display unit.

1. A mobile electronic device comprising:
an operating unit;
a display unit for displaying an idle screen;
a storage unit for storing a first object corresponding to first information and a second object corresponding to second information; and
a control unit for executing a first display process for displaying the first object on the idle screen when the idle screen is displayed, and for executing a second display process for displaying the second object on the idle screen when a preset condition is satisfied after the first display process is executed.

2. The mobile electronic device according to claim 1, wherein
the first information is text information including a letter.

3. The mobile electronic device according to claim 1, wherein
the storage unit further stores third information, and
the second information is information to access the third information.

4. The mobile electronic device according to claim 1, wherein
the condition is satisfied when a preset first period of time has elapsed.

5. The mobile electronic device according to claim 1, wherein
the control unit displays the second object on the idle screen and does not display the first object thereon in the second display process.

6. The mobile electronic device according to claim 1, wherein
the control unit displays the first object together with the second object on the idle screen, in the second display process.

7. The mobile electronic device according to claim 3, wherein
in execution of the second display process, the control unit executes an explanatory display regarding the second object when the second object displayed on the idle screen is selected in accordance with an operation of the operating unit,
and executes an icon display regarding the second object when the second object displayed on the idle screen is not selected.

8. The mobile electronic device according to claim 7, wherein
the control unit accesses the third information corresponding to the second object when the selected second object is decided in accordance with an operation of the operating unit in a state where the second object displayed on the idle screen is selected, in execution of the second display process.

9. The mobile electronic device according to claim 2, wherein
the control unit executes a detail display regarding the text information when the first object displayed on the idle screen is selected and decided in accordance with an operation of the operating unit, in execution of the first display process.

10. The mobile electronic device according to claim 1, wherein:
the storage unit stores a plurality of first objects; and
the control unit changes the first object to be displayed, every time the first display process is executed.

11. The mobile electronic device according to claim 1, wherein
the operating unit has a function call key which is operated to execute a predetermined function, and
the control unit changes from the display process for the idle screen to the display process for the predetermined function when the function call key of the operating unit is operated, in a state where the idle screen is displayed.

12. A display control method for a mobile electronic device, the method comprising:
displaying an idle screen on a display unit;
displaying first object on the idle screen, the first object corresponding to first information; and
displaying second object on the idle screen when a preset condition is satisfied after the first object is displayed, the second object corresponding to second information.
